(19) United States
(12) Patent Application Publication
(10) Pub. No.: US 2003/0093496 A1
(43) Pub. Date: May 15, 2003

(54) Resource service and method for location-independent resource delivery

(76) Inventors: James M. O'Connor, Monmouth Junction, NJ (US); James W. Kerr, Plainsboro, NJ (US); Michael Ogg, West Windsor, NJ (US); Aleta Ricciardi, West Windsor, NJ (US)

Correspondence Address: Stuart D. Rudoler, Wolf, Block, Schorr and Solis-Cohen LLP, 1650 Arch Street, Philadelphia, PA, 19103, US

(21) Appl. No.: 10/135,082

(22) Filed: Apr. 29, 2002

Related U.S. Application Data
(60) Provisional application No. 60/332,388, filed on Oct. 22, 2001.

(51) Int. Cl. G06F 15/16

(52) U.S. Cl. 709/217; 709/226

(57) ABSTRACT

A novel method, system and service for delivering and instantiating resources and services in a distributed system is described. The invention removes dependencies on location, and the need for location-awareness that are present in existing products and practices. Instead of a lookup service pointing to a specific resource base, the invention returns a proxy that uses a resource service to locate and access resources. The present invention provides a highly-available resource base, allows for load balancing resource bases, admits of any other policy-based decisions (such as cost, speed, or quality of service) on where to retrieve a resource from. For service proxy writers, the invention does not require them to commit in advance to an specific code base servers. Using this method, a priori knowledge of specific resource bases is not required, allowing applications to be constructed dynamically and from the most appropriate resources. A similar methodology is also applied to the instantiation of new services, so that the location of a container for a new service need not to be known in advance.

### CROSS REFERENCE TO RELATED APPLICATION

The present application claims the benefit of U.S. Provisional Application No. 60/332,388, filed Oct. 22, 2001, the entire disclosure of which is incorporated herein by reference.

### FIELD OF INVENTION

This invention applies to the field of distributed computing where resources are obtained and delivered in a location independent way. A service, system and method are described that wherein resource delivery does not require a priori knowledge of a specific host location and can be used to search for resources generally. The invention avoids the requirement of a specific host address by using a specialized protocol handler to query a resource service that provides the client with the requested resource. A similar methodology is also applied to the instantiation of new services, so that the location of a container for the service need not to be known in advance.

### BACKGROUND OF INVENTION

A distributed system is a collection of autonomous computing entities, hardware or software, connected by some communication medium. While often the computing entities are geographically dispersed, in some instances they might be separate processors in a multiprocessor computer or even separate software routines executing in logically isolated memory space on the same computer. A computing entity need not be a traditional computer, but more generally can be any computing device, ranging from a large mainframe to a refrigerator or a cell phone. A distributed application is an application that executes on a distributed system and one in which parts of the application execute on distinct autonomous computing entities.

Whenever a distinct component of a distributed application requests something (e.g., a data value, a computation) of another component, the former is called a client and the latter is called a service. It is worth noting that the terms service and client are not exclusionary in that an item can be both a client and a service. For example, a routine that calculates the time between two events may be a client and of a clock service; if the clock service then calls a routine that converts to Daylight Savings Time, the clock becomes a client and the Daylight Savings Time converter is its service.

FIG. 1 shows a typical distributed application of the existing art. There are two clients 2, 4 and four services 10, 12, 14, 16 that the clients 2, 4 might need. Each service has a service proxy 10a, 12a, 14a, 16a which is a module of mobile code that can be used by clients to invoke that service. A service proxy 10a, 12a, 14a, 16a contains the code needed by a client 2, 4 to interact with a service. For instance if a service is a digital camera on a robotic arm, the interfaces might include Initialize( ), Zoom( ), Rotate( ) and Get_Picture( ). The service proxy 10a, 12a, 14a, 16a may also provide the expected return values for the service, which might include error codes as well.

Mobile code generally refers to a computer program that can be written on one platform and executed on numerous others, irrespective of differences in hardware, operating system, file system, and many other details of the execution environment. In addition to independence from the physical characteristics of the execution environment, a mobile program may move from one computer to another in the middle of its execution.

Mobile code may be pre-compiled, or compiled when it arrives at the execution platform. In the first case, numerous versions of the program must be written and compiled, then matched across run-time environments; this is mobile code in the letter, but not the spirit, of the definition. In addition, the same pre-compiled program cannot move from one platform to a different one during its execution. In the second, the program text may be distributed along with configuration scripts describing what to do in each execution environment. This distributes and delays the specificity of the pre-compiled option. The more interesting, and far more common approach exploits a standard virtual machine, which finesses all the issues of platform heterogeneity. The virtual machine is a program that itself mitigates the machine dependencies and idiosyncrasies, taking the raw program text and compiling it into binary executable.

In addition to clients 2, 4 and general services 10, 12, 14, 16, all distributed applications need some mechanism for clients 2, 4 to find services. Often such knowledge is assumed a priori, but many distributed applications use a look-up service 20. The look-up service 20 is a service with which the other services are registered or advertised to be available to for use by clients. In a simple system, where there is no attempt to coordinate replicas of services, each new service registers with the look-up service 20 (in the case of replicas, the onus falls on the client to resolve conflicts and ambiguity). When a service 10, 12, 14, 16 registers, it provides information telling clients 2, 4 how to find it. Commonly, this is a physical location such as an IP address and port number, but in the most modern systems this can be as powerful as giving the look-up service 20 a service proxy 10a, 12a, 14a, 16a, which is actual mobile code that clients 2, 4 can execute and use to invoke that service 10, 12, 14, 16. In this way, the service proxy 10a, 12a, 14a, 16a contains not just location information, but information for how to use the service 10, 12, 14, 16. While just as necessary for the client 2, 4 as location information, this has previously been assumed as a priori knowledge. When a client 2, 4 wishes to work with a service 10, 12, 14, 16 it finds it through the look-up service 20, downloads the service proxy 10a, 12a, 14a, 16a for that service 10, 12, 14, 16 from the look-up service 20, then uses the service proxy 10a, 12a, 14a, 16a to invoke the service 10, 12, 14, 16. The look-up service 20 may also have attributes of the services 10, 12, 14, 16, such as whether it is a grouped service, what type of group it is, what its cost to use is, how accurate it is, how reliable it is, or how long it takes to execute. In such cases the clients 2, 4 can use the attributes to decide which of a number of services 10, 12, 14, 16 it wishes to use.

Each of the foregoing has access to a communication network 22 so that it is capable of communicating with at least some of the other members in the distributed computing application. The communication network 22 may be wireless, a local area network, an internal computer bus, a wide area network such as the Internet, a corporate intranet or extranet, a virtual private network, any other communication medium or any combination of the foregoing.

In the prior art example shown in FIG. 1, one client 2 is a traffic monitoring program that notifies a user when and where traffic has occurred and the other client 4 is an automated toll collection program. The services are a clock 10, a road sensor 12 that monitors traffic flow on a highway, a toll booth sensor 14 that detects an ID device in each car that passes through the toll, and a credit card charge program 16. When each service 10, 12, 14, 16 becomes available to the application it registers with the look-up service 20 and provides the look-up service with its service proxy 10a, 12a, 14a, 16a.

When the traffic monitoring client 2 begins, it queries the look-up service to see if a clock is available and what sensors are available. The look-up service 20 responds by providing the client 2 with the clock proxy 10a, the road sensor proxy 12a and the toll booth sensor proxy 14a. The traffic monitoring client 2 uses the service proxies 10a, 12a, 14a to invoke the clock 10 and the sensors 12, 14, and then to monitor traffic at various times of the day.

Similarly when the toll collector client 4 begins, it queries the look-up service 20 to see if a toll booth sensor 14 and a credit card charge service 16 are available. The look-up service 20 responds by providing the client 4 with the toll booth sensor proxy 14a and the credit card charge proxy 16a. The toll collector client 4 uses the service proxies 14a, 16a, to invoke the toll booth sensor 14 and the credit card charge program 16, and then to identify cars that pass through the toll booth and charge their credit cards for the toll.

Some benefits of distributed computing and mobile code can immediately be seen from this example. First, the clients 2, 4 in FIG. 1 do not need to know ahead of time which sensors 12, 14 are available, or even how many. They simply query the look-up service 20, which provides this information along with the necessary mobile code 12a, 14a to call the sensors. Similarly, the clients 2, 4 do not care which clock 10 is available, as long as any clock 10 is available. Again, this is because through the use of mobile code, a client 2, 4 is provided with the necessary service proxy 10a to invoke and work with the clock 10. Also, the failure or unavailability of a single sensor 12, 14 or other service is not likely to cause the entire application to stop running. Further, the processing load is distributed among a number of computing devices. Also, the various computing entities need not use the same operating system, so long as they conform to a common interface standard.

Jini is one example of a commercially available specification for a distributed object infrastructure (or middleware) for more easily writing, executing and managing object-oriented distributed applications. Jini was developed by Sun Microsystems and is based on the Java programming language; consequently, objects in a Jini system are mobile. Jini is described in Jim Waldo, The Jini Specification, 2nd Edition (2001). The Common Object Request Broker Architecture (CORBA), developed by the Object Management Group, and Distributed Component Object Module (DCOM), developed Microsoft Corporation, are two other commercially available examples that are well known in the prior art. Jini, DCOM, CORBA and a number of other distributed computing specifications are described by Benchiao Jai et al., Effortless Software Interoperability with Jini Connection Technology, Bell Labs Technical Journal, April-June 2000, pp. 88-101, which is hereby incorporated by reference.

In current distributed systems clients and services also require resources. As used herein a “resource” can be broadly understood to be any computing resource: hardware, software, data, image files or code for computations. For example, when a web browser reads a page from a server, many times the html code that describes the page has a pointer to a graphics file that tells the browser where to go to retrieve the graphics file to paste into the page. Similarly, web page servers often point to a different resource to provide advertising (so that advertising can be dynamically changed). Likewise, in distributed computing systems it is often necessary to retrieve code from another location and this code, also called code base or classes, is another common resource. A hardware resource might be a printer or a floating point numeric processor. In these examples, the graphics file, advertising server, mobile code, printer or processor are all resources.

Ideally, distributed middleware should facilitate simple, spontaneous distributed interactions. However existing practices and products limit the flexibility of distributed applications by requiring a priori knowledge of where in the distributed system the resources are located and further limit the type of resource a client can request. Distributed object frameworks, such as CORBA and Jini Network Technology, make headway toward the latter constraint, and Jini makes partial strides in the former, but even there, explicit location information is required for class-loading (the crucial stage in building an object).

An object is composed of the code necessary to execute it, and the object's state. In a Jini system, the service proxy that resides in the lookup service and that is given to clients to execute, contains some code, but also necessarily contains an explicit http address from which the remaining code base is to be retrieved. This commits the proxy writer to designate, in advance, a specific host and location from which the code base will be served. To change that location, the service must be deregistered from the LUS and then reregistered with a new proxy. If the location becomes unavailable, for example due to failure, excessive load, or migration, then the code base cannot be retrieved, the service proxy cannot be constructed, and the service is effectively unavailable for new clients (existing clients would not suffer). The proxy writer, who once the proxy is written is probably getting on with her life, is responsible for monitoring the availability of the code base server. If the proxy is not updated, which few would be except to incorporate changes in the interface, the stale reference for the code base continues to be propagated.

The problem is not limited to client-side proxies of a service but also to creation of the service itself especially if done on behalf of another service (this may happen whenever there are execution dependencies). In this case, the code base contains the code necessary for the whole service, not just the proxy. If the specific code base is unavailable, the service cannot be created, and the dependent service is blocked, possibly resulting in a cascade effect of failures. Moreover, in current practices and products, services can only be instantiated from a local code base (that is, one on the same machine). This precludes building services based on diverse selection criteria, such as performance tuning, or latest version available.

The present invention addresses these inadequacies, and can be applied beyond delivering a code base to dynamically create software objects, but to delivering any resource-base (for example, JPEG images) in a way that is not tied to a specific location from which to retrieve them.

### BRIEF DESCRIPTION OF THE INVENTION

A novel method, system and service for delivering and instantiating resources and services in a distributed system is described. The invention removes dependencies on location, and the need for location-awareness that are present in existing products and practices. Instead of a lookup service pointing to a specific resource base, the invention returns a proxy that uses a resource service to locate and access resources. The present invention provides a highly-available resource base, allows for load balancing resource bases, admits of any other policy-based decisions (such as cost, speed, or quality of service) on where to retrieve a resource from. For service proxy writers, the invention does not require them to commit in advance to an specific code base servers. Using this method, a priori knowledge of specific resource bases is not required, allowing applications to be constructed dynamically and from the most appropriate resources. A similar methodology is also applied to the instantiation of new services, so that the location of a container for a new service need not to be known in advance.

### BRIEF DESCRIPTION OF THE DRAWINGS

FIG. 1 shows an example of a distributed computing application of the prior art.

FIG. 2 shows the use of a plurality of resource services to implement the invention.

FIG. 3 shows the instantiation of a service using a controller to select a service.

FIG. 4 is a flow chart of a novel and location independent method of instantiating a service.

### DESCRIPTION OF THE INVENTION

The present invention uses a new type of service known as a resource service. The resource service is a service that can provide the resources. It may be a dedicated hardware device with high bandwidth for providing large files. Alternatively, the resource service may merely be a Software routine running on a machine that generally operates other services, but happens to contain certain resources that are made available to the distributed community. In another embodiment the resource service may be a gateway to resources existing on another system. A resource service may represent a class of similar resources, such as all traffic sensors, or all network elements, or all mobile phones. Grouping resources hierarchically is key to a highly scalable architecture. Alternately, a resource service may represent a particular subset of business resources exposed by an individual company; this would be likely to protect an enterprise's resources and permit only selected access to them.

Like other services, resource services register with lookup services so that they can be found by other members of the distributed system. A resource service may simply register that it exists (“I am a resource service”), or it may provide the lookup service with the type of resources it has (“I am a resource service with pdf files”), the exact resources it has (“I am a resource service with the following pdf forms: A, B, C”), or even some attributes of its resources (“I am a resource service with free pdf patent forms”). Attributes might include the version of a code base, the resolution of a graphics file, or the fee for using the resource.

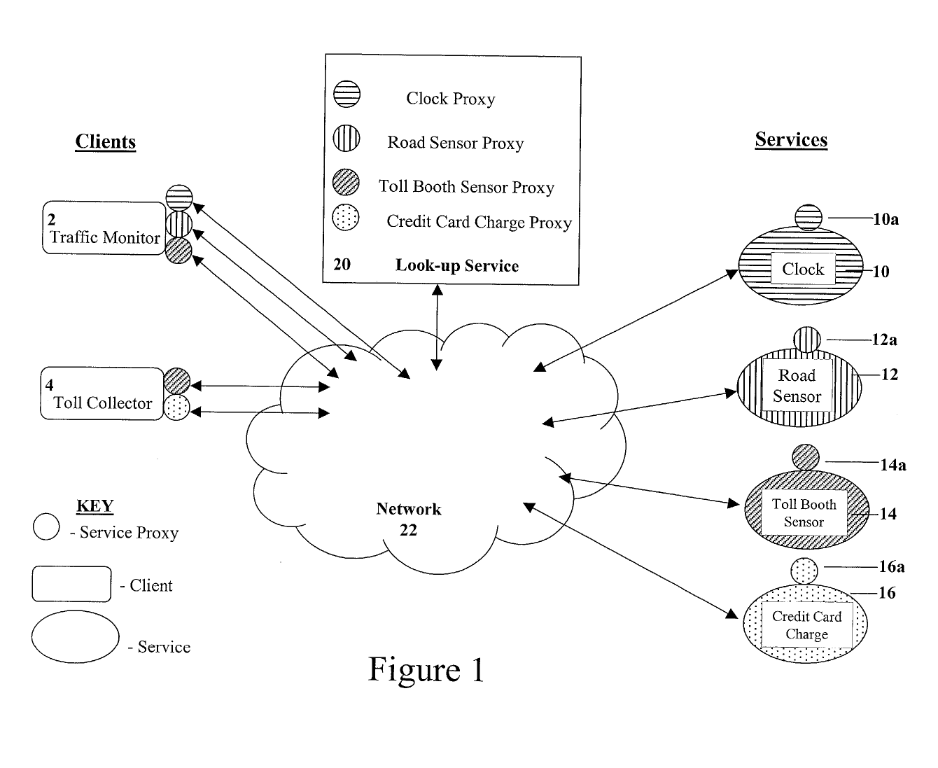

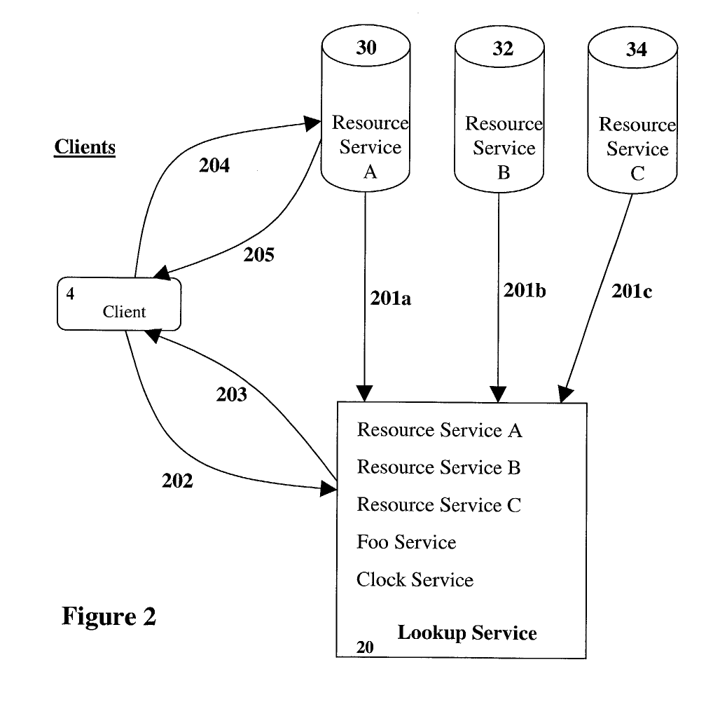

The general method of the invention is shown in FIG. 2. A client 4 requires a resource. (This may be because another service has told a client it needs a resource or the client may already be written to know it needs a certain resource.) A resource is any object, hardware, software, or data that can be used to perform a desired function. Examples of hardware resources are the sensors 12, 14 in FIG. 1, CPUs, memory, computer peripherals printers, storage media, scanners, mouses, keyboards, computers, networks, network hardware such as switches and routers, and wireless devices such as PDA's and telephones. Examples of software include the credit card charge program 16 in FIG. 1, proxies, drivers for hardware devices, virtual machines, compilers, and many services. Examples of data resources are text files, image files, databases, and libraries.

A resource can also be a combination of hardware, software and data. For example, a resource that prints a letter may include a printer, a driver for that printer and a graphic with the corporate letterhead.

The use of the term “location” in this description is not meant to describe a physical location in space but rather an address on a computer network.

In the prior art, the client needs to know, in advance, the specific location of the host at which the resource can be found, as well as the specific mechanism by which the resource will be delivered by the host. In the present invention, as shown in FIG. 2, the client 4 does not need the host location, but merely be able to describe the resource it desires, for example by providing its name (or a matchable substring thereof), attributes, or interface signature. This description is referred to herein as a “descriptor” and in addition to the foregoing, is meant to include any other means of referencing a desired resource. The client 4 requests the resource by providing this descriptor to one or more lookup services 20, using a commonly agreed upon protocol (such as http) 202.

Prior to this, one or more resource services 30, 32, 34 have registered with the lookup services 201a, b, c. Each resource service, if necessary, provides its own proxy (the resource service proxy) to the lookup service when it registers. As with other proxies, the resource service proxy is mobile code. The resource service proxy is comprised of a protocol handler and/or necessary interfaces code, so that when a client receives them from the lookup service, it can immediately execute them to query the resource service and then acquire the resource. In the preferred embodiment, from the perspective of the client 4, this resource service proxy appears to simply be the proxy for the requested resource. Allowing resource-service specific protocol handlers to be distributed, rather than assuming some commonly used framework, allows legacy systems to become part of and interwork within the larger distributed architecture. In the case of exposing enterprise resource, secure communication and access control may be required, while exposing available sensors may require nothing more than the Unix file transfer protocol (ftp).

The lookup service 20 responds to the client with the protocol handler and interfaces (resource service proxy) of one or more resource services 203. Depending on the resource descriptor provided by the client, and self-descriptive attributes provided by a resource service 30, 32, 34, the lookup service 20 may be able to determine which of the registered resource services 30, 32, 34 contain the desired resource and respond to the client 4 with only those resources services 30, 32, 34. For example, the sensor resource service may register itself as a resource service, as a resource service with sensors, or simply as a sensor. In any case, the protocol handler the sensor resource service provides to the lookup service 20 would include all code necessary for further querying it for (individual) sensors. Absent the lookup service 20 returning the proxy for a specific single resource service, the client 4 may need to query a number of resource services 30, 32, 34 to obtain the particular resource it requires.

The client 4 requests the desired resource from the resource service(s) 204 using the protocol handler(s) and interfaces it has been given in the resource service proxy; the resource descriptor the client 4 originally provided to the lookup service 20 is transformed, by the handler or some auxiliary translation logic, to the syntax required by the resource service or protocol handler. The resource service 30 then provides the client 4 with the resource or the tools necessary to acquire the resource. 205 As described above, the resource service proxy is specific to a particular resource service, but in an alternative embodiment a resource service proxy may be capable of locating and querying any number of resource services or lookup services.

In the preferred embodiment, resources register themselves with resource services by providing descriptors and their own protocol handlers. However a resource service may also use a discovery protocol to locate resources and query them for their descriptors; a resource service may discover resources then create descriptions for them; a resource service may pass the descriptors, or parts of the descriptors, on to one or more lookup services.

For purposes of clarity, a resource descriptor stored with a resource service or lookup service is termed a profile. When a resource service receives a request from a client for a resource, it compares the descriptor sent by the client to the resource profiles it has. The resource profile then returns a number of resource profiles that match (not necessarily identically) the descriptor. The client (or a proxy) can then analyze the profiles and decide which resource it wishes to use. Such analysis may be based on the closeness of fit between the profile and the descriptor, version date (e.g. use the latest version), cost, reliability, availability, speed or a combination of these or other factors. The analysis may be relatively unintelligent, like taking the first in the list. In an alternative embodiment the analysis is performed by the resource service to select the best resource, so that the resource service only returns one resource profile. In some architectures it is preferable to have the analysis intelligence in the client (or a proxy used by the client) so that the analysis can be performed across multiple resource services.

Acquiring a resource may be as simple as downloading a data file directly from the resource service. Alternatively, the resource service may not actually have the desired resource and may provide the client 4 with a resource-specific protocol handler, essentially providing the mechanism for accessing the specific location where the resource resides. Also, the client 4 may not actually download the resource, but may instead simply access it, such as writing to a printer. Acquiring a resource may be a multistep complex operation, such as downloading and compiling a proxy or device driver from another location in order to send a message to a pager or to another piece of software. In any event, the resource service provides the client with the necessary mechanisms to locate and acquire the desired resource.

The present embodiment can be seen as providing a location-independent mechanism for accessing resources in general, and extending the Jini lookup and discovery protocol in particular. Rather than respond with the bound URL of the resource, as Jini specifies, the present embodiment responds with a protocol handler and protocol execution for querying resource services for the resource. Because the resource provider need no longer be bound to the resource descriptor at the time the resource is registered with the lookup service, the selection of resource delivery can be policy-based (e.g., cheapest price, fastest access), and the resource can be relocated (e.g., for hardware improvements) or substituted (e.g., updated) without having to reregister it with the lookup service. The general invention allows of dynamically redirecting to a resource service allows independent domains of resources to be exposed and served according to a domain-specific policy or domain-specific requirements. Redirection also allows for hierarchical grouping of resources for scalability.

In FIG. 2, only one lookup service 20 is shown, however, in many distributed systems, there are a plurality of lookup services, and it is possible that each lookup service has different services registered. In such a case, the correct lookup service (or services) can be specified in advance; however, this is not optimal because it requires a priori knowledge of the correct lookup service and if that lookup service is unavailable this will result in a failure. In the preferred embodiment, the lookup service is not specified, and the client multicasts to all reachable lookup services in its logical environment (perhaps through unicasting between multicast domains and/or any other discovery protocol) for available resource services. Again, in the preferred embodiment, the multicast can include a descriptor of a specific resource and the lookup services will return only those resource services with that resource.

Multicasting is a well known protocol for discovering the existence of objects within a domain. While multicasting is used here, other discovery methods now known or later invented, such as polling, unicasting, unicasting between multicast domains, can be used instead of or in combination with multicasting.

Just as at times the location of resource being sought is not (and should not need to be) known in advance, at times the location that an object will be created on is not (and should not need to be) known in advance. A container is a logical space in memory that an object can be created in. Through the use of mobile code this container need not have its location fixed in advance. It may be on any computing entity available with sufficient resources for the task.

In the prior art, a known container was used and the client makes an explicit call to that container (such as “create(Foo)”) to create an object. If any resources are required (such as a copy of the code used for that object) the client or the container must know the location of those resources and call them, or in many cases (most notably Java) were restricted to be in the same local virtual machine.

Just as resource services contain resource profiles, controllers may have container profiles that they may use to catalogue and select the available containers.

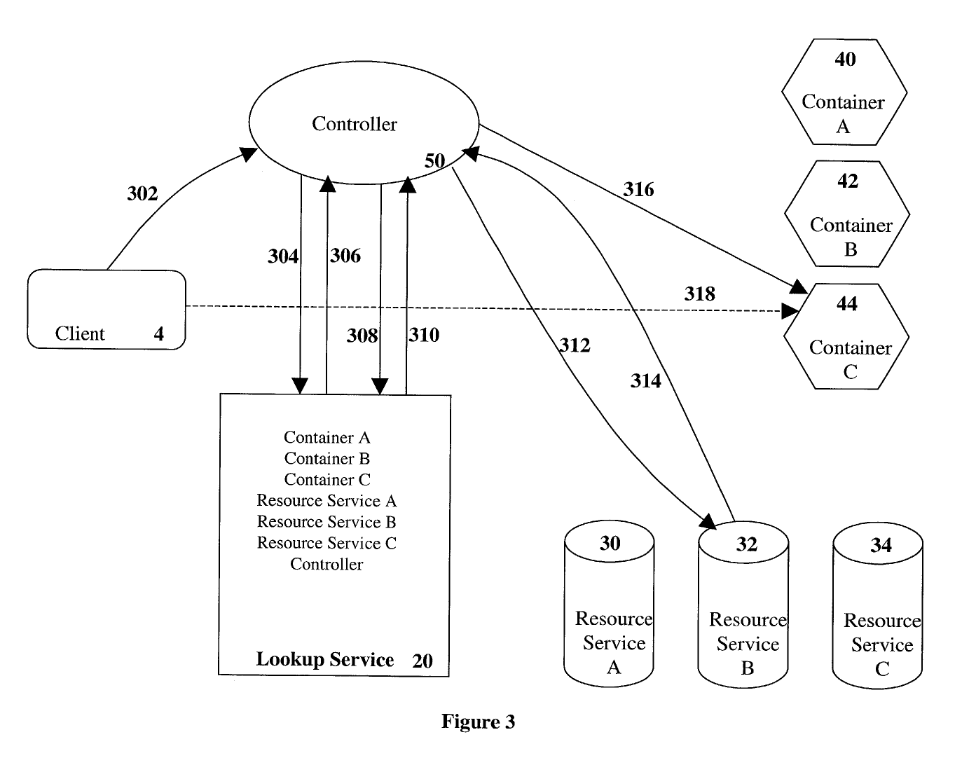

FIG. 3 shows an improved system and method of the current invention for creating an object. A new service type, called a controller 50 is added to the distributed environment. A controller is responsible for monitoring computing entities in the distributed environment and pairing up containers with objects. The containers register with the lookup service 20 (and/or with the controller 50) when they enter the environment and give the lookup service (and/or the controller) their service profiles. Certain containers may only be able to perform certain types of tasks (such as parallel processing), or may be able to optimally perform specific tasks (such as fast security encryption and decryption or floating point calculations). Containers may also describe the amount of memory they have or the number of objects they can contain simultaneously.

When a client 4 needs an object, for example a Foo service, it queries the lookup service 20 for a Foo service (not shown). As used herein a “Foo” can be any service, which could provide any functionality. A Foo could be, among other services, a clock, a counter, a display driver, a traffic sensor or a calculator. Assuming no Foos exist yet, the lookup service responds that there are no Foos (not shown). The client 4 then sends a command to create a Foo to the controller 50, 302, which in turn decides which container to use to create a Foo. (Alternatively, the lookup service may instruct the controller to create a Foo.) The controller 50 then queries the lookup service 20 to determine what containers 40, 42, 44 are available to create Foo in 304, 306. (Alternatively, the controller may have previously queried the lookup service for containers or the containers may have registered directly with the controller.) The controller selects a container (in this example Container C 44). This selection may be based on the attributes of the container, load balancing, or other criteria. Assuming that certain resources are required to instantiate a Foo (such as Foo Code), the controller multicasts to available lookup services 20 requesting a resource service with Foo Code 308, 310 (in this case Resource Service B 32). The controller 50 downloads the needed resource(s) from the resource service(s) 30, 32, 34, 312, 314 and provides the resource(s) to the selected container 44, 316 and instructs the container to instantiate a Foo. (Alternatively, the controller 50 might just provide the container 44 with the address where the resource(s) can be found or the container might query the lookup service itself for resource services).

Now that the object, a Foo service, has been created, the client 4 can make its intended call to Foo 318. Prior to making this call, it may be necessary for the Foo to register with the lookup service 20 and for the client to download the Foo service proxy from the lookup service (not shown).

In this way, the client 4 is not burdened with the need to know which container to use, or where the container is in advance. In addition, if any resources are needed to create the object, the controller locates those resources and provides them to the container. While it is preferable for resources to be located using a resource service, the location of resources may be defined in advance, as in the prior art.

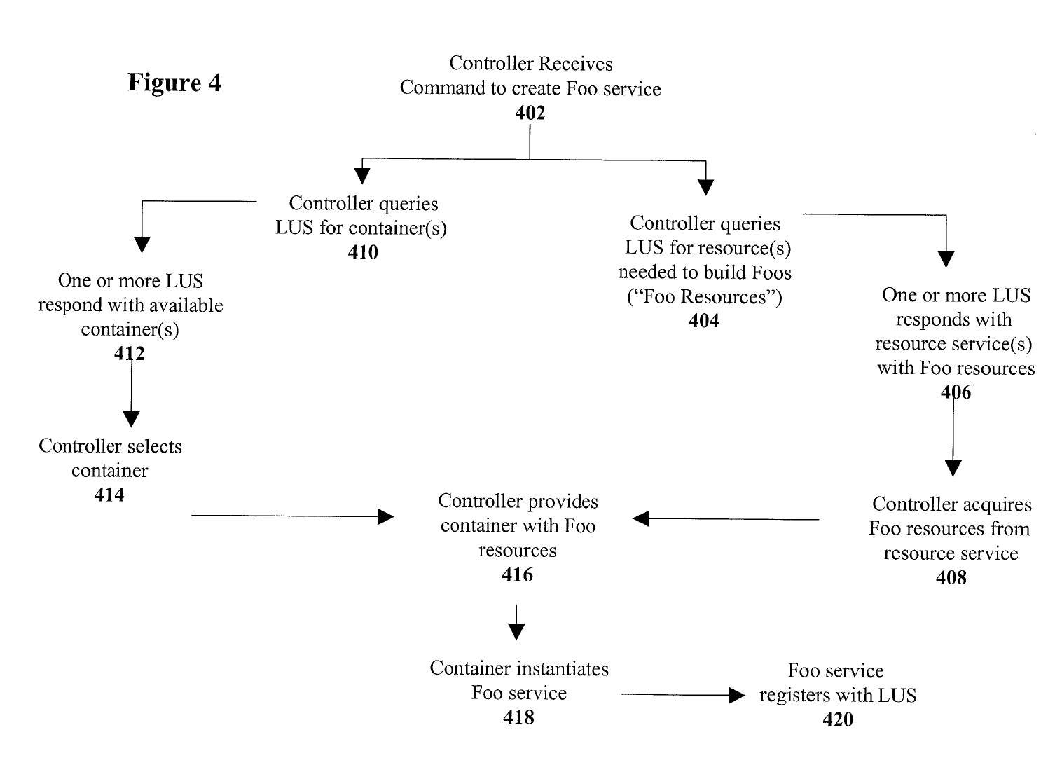

FIG. 4 shows a flow chart of this improved method for locating containers and instantiating objects in greater detail for creating a Foo service. The controller receives a command 402 to create a Foo service. In response, the controller may query one (unicast) or all lookup services in its logical environment (multicast) 404 for a resource service with the necessary resources to build a Foo service (“Foo Resources”). One or more lookup services respond 406 with the address of the resource service with the Foo Resources. Alternatively, the query can filter on particular variables such as version number of Foo, to limit the number of responses. The controller sorts the responses and using the addresses provided downloads the Foo Resources from the resource service 408.

Additionally, the controller must locate a container in its distributed environment to create the service. As the location of the container is not known, a process similar to locating a resource service is used to locate and select an appropriate container. The controller queries the lookup service(s) 410 requesting a container with a particular profile for creation of the new service. The lookup service provides the controller with all instances of containers in its distributed environment 412 according to the request and the controller sorts responses by profile to select an appropriate container 414. Once a container is selected, the controller provides the container with the Foo Resources 416 retrieved from the resource service and the Foo is created 418.

Preferably, the new Foo service then registers with one or more lookup services 420. A similar method can be used to instantiate an object without a container in architectures that do not use containers.

Thus, using the current invention, a service may be created without knowing the location of the container or of the resource or resource service. Each entity, container services and resource services, register with the lookup service enabling the controller to locate the appropriate entities in its distributing environment to instantiate the service. Similarly, like any other service, there may be a plurality of controllers.

It is understood that the invention is not limited to the disclosed embodiments, but on the contrary, is intended to cover various modifications and equivalent arrangements included within spirit and scope of the appended claims. Without further elaboration, the foregoing will so fully illustrate the invention, that others may by current or future knowledge, readily adapt the same for use under the various conditions of service.

What is claimed is:

1. A method of locating and accessing a resource in a distributed computing system comprising the steps of:
querying a lookup service to locate a resource service;
receiving a resource service proxy from the lookup service;
using the resource service proxy to acquire the resource from a location specified by the resource service.

2. The method of claim 1 wherein the step of querying the lookup service is comprised of unicasting or multicasting.

3. The method of claim 1 wherein the resource service registers with the lookup service.

4. The method of claim 3 wherein the resource service provides the resource service proxy when it registers with the lookup service.

5. The method of claim 3 wherein the resource service registers the resources it can provide with the lookup service.

6. The method of claim 1 wherein the resource is a computer hardware, CPU, memory, peripheral, printer, storage media, network hardware, switch, router, wireless device, PDA, telephone, software, database, text file, code file, data file, image file or library.

7. The method of claim 1 further comprising the steps of:
querying the resource service with a resource descriptor;
receiving from the resource service one or more resource profiles that match the resource descriptor; and
analyzing the one or more profiles to select a resource.

8. The method of claim 7 wherein resources register their profiles with the resource service.

9. The method of claim 7 wherein a plurality of resource services are queried.

10. The method of claim 1 wherein the step of acquiring the resource consists of accessing the resource, downloading the resource, instantiating the resource, instantiating a link to the resource, and sending instructions to the resource.

11. The method of claim 1 wherein the resource service proxy is comprised of a protocol handler.

12. The method of claim 1 wherein the resource service proxy is comprised of an interface.

13. The method of claim 1 wherein the resource service acts as a gateway to another computer network.

14. The method of claim 1 wherein the step of querying a lookup service is comprised of querying a lookup service for a resource.

15. The method of claim 1 wherein a plurality of lookup services are queried.

16. The method of claim 1 wherein the lookup service provides the location of the resource service.

17. A computer readable medium containing instructions for controlling a computer system to perform a method of locating and accessing a resource in a distributed computing system comprising the steps of:
querying a lookup service to locate a resource service;
receiving a resource service proxy from the lookup service;
using the resource service proxy to acquire the resource from a location specified by the resource service.

18. The computer readable medium of claim 17 wherein the step of querying the lookup service is comprised of unicasting or multicasting.

19. The computer readable medium of claim 17 wherein the resource service registers with the lookup service.

20. The computer readable medium of claim 19 wherein the resource service provides the resource service proxy when it registers with the lookup service.

21. The computer readable medium of claim 19 wherein the resource service registers the resources it can provide with the lookup service.

22. The computer readable medium of claim 17 wherein the resource is a computer hardware, CPU, memory, peripheral, printer, storage media, network hardware, switch, router, wireless device, PDA, telephone, software, database, text file, code file, data file, image file or library.

23. The computer readable medium of claim 17 wherein the method is further comprised of the steps of:
querying the resource service with a resource descriptor;
receiving from the resource service one or more resource profiles that match the resource descriptor; and
analyzing the one or more profiles to select a resource.

24. The computer readable medium of claim 23 wherein resources register their profiles with the resource service.

25. The computer readable medium of claim 23 wherein a plurality of resource services are queried.

26. The computer readable medium of claim 17 wherein the step of acquiring the resource consists of accessing the resource, downloading the resource, instantiating the resource, instantiating a link to the resource, and sending instructions to the resource.

27. The computer readable medium of claim 17 wherein the resource service proxy is comprised of a protocol handler.

28. The computer readable medium of claim 17 wherein the resource service proxy is comprised of an interface.

29. The computer readable medium of claim 17 wherein the resource service acts as a gateway to another computer network.

30. The computer readable medium of claim 17 wherein the step of querying a lookup service is comprised of querying a lookup service for a resource.

31. The computer readable medium of claim 17 wherein a plurality of lookup services are queried.

32. The computer readable medium of claim 17 wherein the lookup service provides the location of the resource service.

33. A method of locating a resource in a distributed computing system comprising the steps of:
querying a lookup service with a resource descriptor;
receiving a resource service proxy from the lookup service;
using the resource service proxy to query a resource service with a resource descriptor;
receiving one or more resource profiles from the resource service of one or more resources that match the resource descriptor;
analyzing the one or more resource profiles to select one of the one or more matching resources; and
acquiring the selected resource from a location specified by the resource service.

34. The method of claim 33 wherein the step of querying the lookup service is comprised of unicasting or multicasting.

35. The method of claim 33 wherein the resource service registers with the lookup service.

36. The method of claim 35 wherein the resource service provides the resource service proxy when it registers with the lookup service.

37. The method of claim 35 wherein the resource service registers the resources it can provide with the lookup service.

38. The method of claim 33 wherein the resource is a computer hardware, CPU, memory, peripheral, printer, storage media, network hardware, switch, router, wireless device, PDA, telephone, software, database, text file, code file, data file, image file or library.

39. The method of claim 33 wherein resources register their profiles with the at least one resource service.

40. The method of claim 33 wherein a plurality of resource services are queried.

41. The method of claim 33 wherein the step of acquiring the resource is further comprised of accessing the resource, downloading the resource, instantiating the resource, instantiating a link to the resource, sending instructions to the resource.

42. The method of claim 33 wherein the resource service proxy is comprised of a protocol handler.

43. The method of claim 33 wherein the resource service proxy is comprised of an interface.

44. The method of claim 33 wherein the resource service acts as a gateway to another computer network.

45. The method of claim 33 wherein the step of querying a lookup service is comprised of querying a lookup service for a resource.

46. The method of claim 33 wherein a plurality of lookup services are queried.

47. The method of claim 33 wherein the lookup service provides the location of the resource service.

48. A computer readable medium containing instructions for controlling a computer system to performa method of locating a resource in a distributed computing system comprising the steps of:
querying a lookup service with a resource descriptor;
receiving a resource service proxy from the lookup service;
using the resource service proxy to query a resource service with a resource descriptor;
receiving one or more resource profiles from the resource service of one or more resources that match the resource descriptor;
analyzing the one or more resource profiles to select one of the one or more matching resources; and
acquiring the selected resource from a location specified by the resource service.

49. The method of claim 48 wherein the step of querying the lookup service is comprised of unicasting or multicasting.

50. The method of claim 48 wherein the resource service registers with the lookup service.

51. The method of claim 50 wherein the resource service provides the resource service proxy when it registers with the lookup service.

52. The method of claim 50 wherein the resource service registers the resources it can provide with the lookup service.

53. The method of claim 48 wherein the resource is a computer hardware, CPU, memory, peripheral, printer, storage media, network hardware, switch, router, wireless device, PDA, telephone, software, database, text file, code file, data file, image file or library.

54. The method of claim 48 wherein resources register their profiles with the at least one resource service.

55. The method of claim 48 wherein a plurality of resource services are queried.

56. The method of claim 48 wherein the step of acquiring the resource is further comprised of accessing the resource, downloading the resource, instantiating the resource, instantiating a link to the resource, sending instructions to the resource.

57. The method of claim 48 wherein the resource service proxy is comprised of a protocol handler.

58. The method of claim 48 wherein the resource service proxy is comprised of an interface.

59. The method of claim 48 wherein the resource service acts as a gateway to another computer network.

60. The method of claim 48 wherein the step of querying a lookup service is comprised of querying a lookup service for a resource.

61. The method of claim 48 wherein a plurality of lookup services are queried.

62. The method of claim 48 wherein the lookup service provides the location of the resource service.

63. A resource service comprised of:
a computer processor;
a storage medium;
a plurality of resource profiles stored on the storage medium;
a software module for receiving a resource descriptor from a requesting object;
a software module for matching the resource descriptor to one or more of the plurality of resource profiles; and
a software module for sending the matched one or more resource profiles to the requesting object.

64. The resource service of claim 63 further comprised of a software module that allows resources to register with the resource service.

65. The resource service of claim 63 wherein the resource service registers profiles with a lookup service.

66. The resource service of claim 63 wherein the resource service registers itself with a lookup service.

67. The resource service of claim 63 further comprised of a high bandwidth communication device.

68. The resource service of claim 63 further comprised of a number of resources stored on the storage medium.

69. The resource service of claim 63 wherein each of the plurality of resource profiles is comprised of the location of a resource.

70. The resource service of claim 63 wherein the resource service acts as a gateway to another computer network.

71. A distributed computing system comprised of:
a plurality of computing devices connected by a communication network;
a resource service operating on at least one of the computing devices and providing access to a resource;
a resource service proxy comprised of mobile code, operating on at least one of the computing devices;
a client operating on at lest one of the computing devices;
wherein the client uses the resource service proxy to acquire the resource from the resource service.

72. The distributed computing system of claim 71 further comprised of a lookup service wherein the resource service registers the resource service proxy with the lookup service and the client obtains the resource service proxy from the lookup service.

73. The distributed computing system of claim 71 further comprised of a plurality of resource services.

74. The distributed computing system of claim 73 wherein the client queries more than one resource service for a resource.

75. The distributed computing system of claim 71 wherein the resource service proxy is comprised of a protocol handler.

76. The distributed computing system of claim 71 wherein the resource service proxy is comprised of an interface.

77. A method of instantiating an object in a distributed computing system comprising the steps of:
sending a command to a controller to instantiate the object;
the controller selecting a container;
providing a resource to the selected container; and
the selected container using the resource to instantiate the object.

78. The method of claim 77 further comprising the step of locating a resource for instantiating the object.

79. The method of claim 77 wherein the step of selecting a container further comprises:
querying at least one lookup service for available containers;
receiving from the at least one lookup service one or more container profiles of available containers; and
analyzing the one or more profiles to select a container.

80. The method of claim 77 wherein the step of providing a resource to the selected container further comprises the steps of:
querying at least one lookup service to locate at least one resource service; and
acquiring the resource from a location specified by the at least one resource service.

81. The method of claim 77 wherein the step of providing a resource is performed by the controller or the selected container.

82. A computer readable medium containing instructions for controlling a computer system to perform a method of instantiating an object in a distributed computing system comprising the steps of:
sending a command to a controller to instantiate the object;
the controller selecting a container;
providing a resource to the selected container; and
the selected container using the resource to instantiate the object.

83. The computer readable medium of claim 82 wherein the method is further comprised of the step of locating a resource for instantiating the object.

84. The computer readable medium of claim 82 wherein the step of selecting a container further comprises:
querying at least one lookup service for available containers;
receiving from the at least one lookup service one or more container profiles of available containers; and
analyzing the one or more profiles to select a container.

85. The computer readable medium of claim 82 wherein the step of providing a resource to the selected container further comprises the steps of:
querying at least one lookup service to locate at least one resource service; and
acquiring the resource from a location specified by the at least one resource service.

86. The computer readable medium of claim 82 wherein the step of providing a resource is performed by the controller or the selected container.

87. A method of instantiating an object in a distributed computing system comprising the steps of:
sending a command to a controller to instantiate an object;
the controller sending a query to at least one lookup service for an available container;
the controller receiving one or more container profiles of available containers from the at least one lookup service;
the controller analyzing the one or more container profiles to select a container;
the controller selecting a container;
the controller locating and providing a resource to the selected container; and
the container using the resource to instantiate the object.

88. The method of claim 87 wherein the step of providing a resource to the selected container further comprises the steps of:
querying at least one lookup service to locate at least one resource service; and
acquiring the resource from a location specified by the at least one resource service.

89. A computer readable medium containing instructions for controlling a computer system to perform a method of instantiating an object in a distributed computing system comprising the steps of:
sending a command to a controller to instantiate an object;
the controller sending a query to at least one lookup service for an available container;
the controller receiving one or more container profiles of available containers from the at least one lookup service;
the controller analyzing the one or more container profiles to select a container;
the controller selecting a container;
the controller locating and providing a resource to the selected container; and
the container using the resource to instantiate the object.

90. The computer readable medium of claim 89 wherein the step of providing a resource to the selected container further comprises the steps of:
querying at least one lookup service to locate at least one resource service; and
acquiring the resource from a location specified by the at least one resource service.

91. A controller service comprised of:
a computer processor;
a storage medium;
a software module for receiving an instruction to instantiate an object;
a software module for locating and selecting a resource needed to instantiate the object; and
a software module for locating and selecting a container for the object.

92. The controller service of claim 91 further comprising a software module for providing the selected resource to the selected container.

93. The controller service of claim 91 further comprising a software module for instructing the container to instantiate the object.

94. The controller service of claim 91 further comprising a software module that allows the controller service to register with a lookup service.

95. The controller service of claim 91 further comprised of a plurality of container profiles stored on the storage medium.

96. The controller service of claim 91 wherein each of the container profiles is comprised of the location of the container.
